(19) United States
(12) Patent Application Publication
(10) Pub. No.: US 2026/0177109 A1
(43) Pub. Date: Jun. 25, 2026

(54) POWER TRANSMISSION DEVICE

(71) Applicant: EXEDY Corporation, Neyagawa-shi (JP)

(72) Inventor: Hiroshi UEHARA, Neyagawa-shi (JP)

(21) Appl. No.: 19/400,668

(22) Filed: Nov. 25, 2025

(30) Foreign Application Priority Data
Dec. 25, 2024 (JP) 2024-228459
Jun. 13, 2025 (JP) 2025-099216

(51) Int. Cl. F16D 3/12; F16D 3/66; F16D 7/02

(52) U.S. Cl. CPC F16D 3/12; F16D 3/66; F16D 7/025

(57) ABSTRACT

A present power transmission device includes a drive plate and a torque fluctuation inhibiting device. The drive plate is configured to receive a torque outputted from a prime mover. The torque fluctuation inhibiting device is disposed on a first side of the drive plate in an axial direction. The torque fluctuation inhibiting device is configured to be attached to the drive plate. The drive plate includes a disc portion and a first cylindrical portion. The first cylindrical portion extends from an outer peripheral end of the disc portion to the first side in the axial direction.

### CROSS-REFERENCE TO RELATED APPLICATIONS

This application is based on and claims the priority benefit of Japanese applications Nos. 2024-228459 filed on December 25, 2024, and 2025-099216 filed on June 13, 2025, the contents of which are incorporated herein by reference.

### TECHNICAL FIELD

The present invention relates to a power transmission device.

### BACKGROUND

A power transmission device disclosed in Japan Laid-open Patent Application Publication No. 2024-030506 includes a flywheel, a torque limiter, and a damper unit. The flywheel includes a flexible plate and an inertia ring. The torque limiter is attached to the inertia ring.

### SUMMARY OF THE INVENTION

It is an object of the present invention to provide a power transmission device obtainable at a low cost.

A power transmission device according to a first aspect includes a drive plate and a torque fluctuation inhibiting device. The drive plate is configured to receive a torque outputted from a prime mover. The torque fluctuation inhibiting device is disposed on a first side of the drive plate in an axial direction. The torque fluctuation inhibiting device is configured to be attached to the drive plate. The drive plate includes a disc portion and a first cylindrical portion. The first cylindrical portion extends from an outer peripheral end of the disc portion to the first side in the axial direction.

According to the configuration, the drive plate includes the first cylindrical portion; hence, the first cylindrical portion is enabled to function as at least a part of an inertia ring. Because of this, the inertia ring can be omitted at least in part. It should be noted that the inertia ring is generally formed by casting, whereas the drive plate is generally formed by sheet metal processing or stamping of a metallic plate. Here, the drive plate formed by sheet metal processing or stamping is lower in cost than the inertia ring formed by casting. Hence, the power transmission device is made obtainable at a low cost.

A power transmission device according to a second aspect relates to the power transmission device according to the first aspect and is configured as follows. The torque fluctuation inhibiting device includes a contact surface oriented radially outward. The contact surface is in contact with an inner peripheral surface of the first cylindrical portion. According to the configuration, it is made possible to set in place the torque fluctuation inhibiting device by the first cylindrical portion.

A power transmission device according to a third aspect relates to the power transmission device according to the first or second aspect and is configured as follows. The torque fluctuation inhibiting device includes an annular portion and a second cylindrical portion. The annular portion extends in a circumferential direction. The second cylindrical portion extends from an outer peripheral end of the annular portion in the axial direction. The first cylindrical portion overlaps with the second cylindrical portion as seen in a radial direction.

A power transmission device according to a fourth aspect relates to the power transmission device according to the third aspect and is configured as follows. The first cylindrical portion is disposed radially outside the second cylindrical portion.

A power transmission device according to a fifth aspect relates to the power transmission device according to the fourth aspect and is configured as follows. An inner peripheral surface of the first cylindrical portion is in contact with an outer peripheral surface of the second cylindrical portion.

A power transmission device according to a sixth aspect relates to the power transmission device according to any of the third to fifth aspects and is configured as follows. The second cylindrical portion extends from the outer peripheral end of the annular portion to the first side in the axial direction.

A power transmission device according to a seventh aspect relates to the power transmission device according to the sixth aspect and is configured as follows. The torque fluctuation inhibiting device includes a coupling portion and a third cylindrical portion. The coupling portion extends radially outward from a distal end of the second cylindrical portion. The third cylindrical portion extends from an outer peripheral end of the coupling portion to a second side in the axial direction. The first cylindrical portion is disposed radially between the second and third cylindrical portions.

A power transmission device according to an eighth aspect relates to the power transmission device according to the seventh aspect and further includes a vibration absorbing member. The vibration absorbing member is disposed axially between the coupling portion and the first cylindrical portion.

A power transmission device according to a ninth aspect relates to the power transmission device according to any of the first to eighth aspects and further includes an inertia member. The inertia member is configured to be rotated unitarily with the drive plate.

A power transmission device according to a tenth aspect relates to the power transmission device according to the ninth aspect and is configured as follows. The inertia member is disposed axially between the drive plate and the torque fluctuation inhibiting device.

A power transmission device according to an eleventh aspect relates to the power transmission device according to the ninth or tenth aspect and is configured as follows. The inertia member is disposed to overlap with the first cylindrical portion as seen in a radial direction.

A power transmission device according to a twelfth aspect relates to the power transmission device according to any of the ninth to eleventh aspects and is configured as follows. The inertia member includes a screw hole extending in the axial direction.

A power transmission device according to a thirteenth aspect relates to the power transmission device according to any of the ninth to twelfth aspects and is configured as follows. The inertia member is a nut with a thickness larger than a plate thickness of the drive plate.

A power transmission device according to a fourteenth aspect relates to the power transmission device according to any of the ninth to twelfth aspects and is configured as follows. The inertia member is made in shape of an annulus extending in a circumferential direction. The inertia member is larger in plate thickness than the drive plate.

A power transmission device according to a fifteenth aspect relates to the power transmission device according to any of the first to fourteenth aspects and is configured as follows. The torque fluctuation inhibiting device includes at least either of a torque limiter and a damper unit. The torque limiter includes a first side plate, a friction plate, a pressure plate, and an urging member. The first side plate is configured to be rotated unitarily with the drive plate. The friction plate is disposed to be rotatable relative to the first side plate. The pressure plate holds the friction plate in cooperation with the first side plate, with the friction plate interposed therebetween. The urging member urges the pressure plate toward the first side plate in the axial direction. The damper unit includes a first rotary member, a second rotary member, and an elastic member. The second rotary member is disposed to be rotatable relative to the first rotary member. The elastic member elastically couples the first and second rotary members therethrough to each other.

A power transmission device according to a sixteenth aspect relates to the power transmission device according to the fifteenth aspect and is configured as follows. The torque limiter includes a second side plate. The friction plate, the pressure plate, and the urging member are disposed axially between the first and second side plates.

A power transmission device according to a seventeenth aspect relates to the power transmission device according to the sixteenth aspect and is configured as follows. The second side plate is disposed axially between the drive plate and the first side plate.

A power transmission device according to an eighteenth aspect relates to the power transmission device according to any of the fifteenth to seventeenth aspects and is configured as follows. The elastic member is disposed radially inside the torque limiter.

A power transmission device according to a nineteenth aspect relates to the power transmission device according to any of the first to eighteenth aspects and is configured as follows. The torque fluctuation inhibiting device includes an annular portion extending in a circumferential direction. The first cylindrical portion is in contact at an inner peripheral surface thereof with an outer peripheral surface of the annular portion.

Overall, according to the present invention, a power transmission device is made obtainable at a low cost.

### BRIEF DESCRIPTION OF THE DRAWINGS

FIG. 1 is a plan view of a power transmission device.

FIG. 2 is a cross-sectional view of the power transmission device taken along line II-II in FIG. 1.

FIG. 3 is an enlarged cross-sectional view of the power transmission device.

FIG. 4 is an enlarged cross-sectional view of a power transmission device according to a modification.

FIG. 5 is an enlarged cross-sectional view of a power transmission device according to another modification.

FIG. 6 is a plan view of a power transmission device according to yet another modification.

FIG. 7 is a cross-sectional view of the power transmission device taken along line VII-VII in FIG. 6.

FIG. 8 is a plan view of a power transmission device according to still another modification.

FIG. 9 is a cross-sectional view of a power transmission device according to still yet another modification.

FIG. 10 is an enlarged cross-sectional view of a power transmission device according to further still yet another modification.

### DETAILED DESCRIPTION

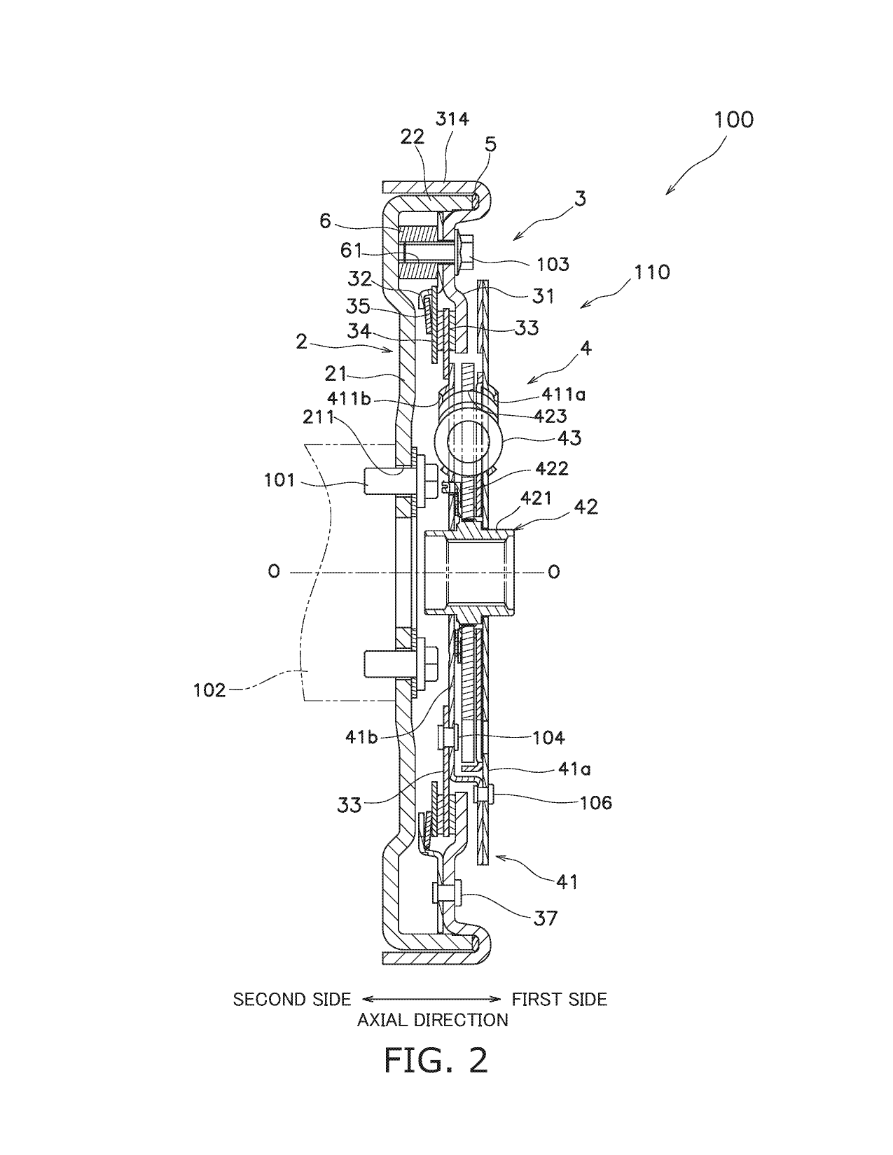

A power transmission device 100 according to the present preferred embodiment will be hereinafter explained with reference to drawings. It should be noted that in the following explanation, the term “axial direction” refers to an extending direction of a rotational axis O for the power transmission device 100. On the other hand, the term “circumferential direction” refers to a circumferential direction of an imaginary circle about the rotational axis O, whereas the term “radial direction” refers to a radial direction of the imaginary circle about the rotational axis O. In addition, the term “first side in the axial direction” means the right side in FIG. 2, whereas the term “second side in the axial direction” means the left side in FIG. 2.

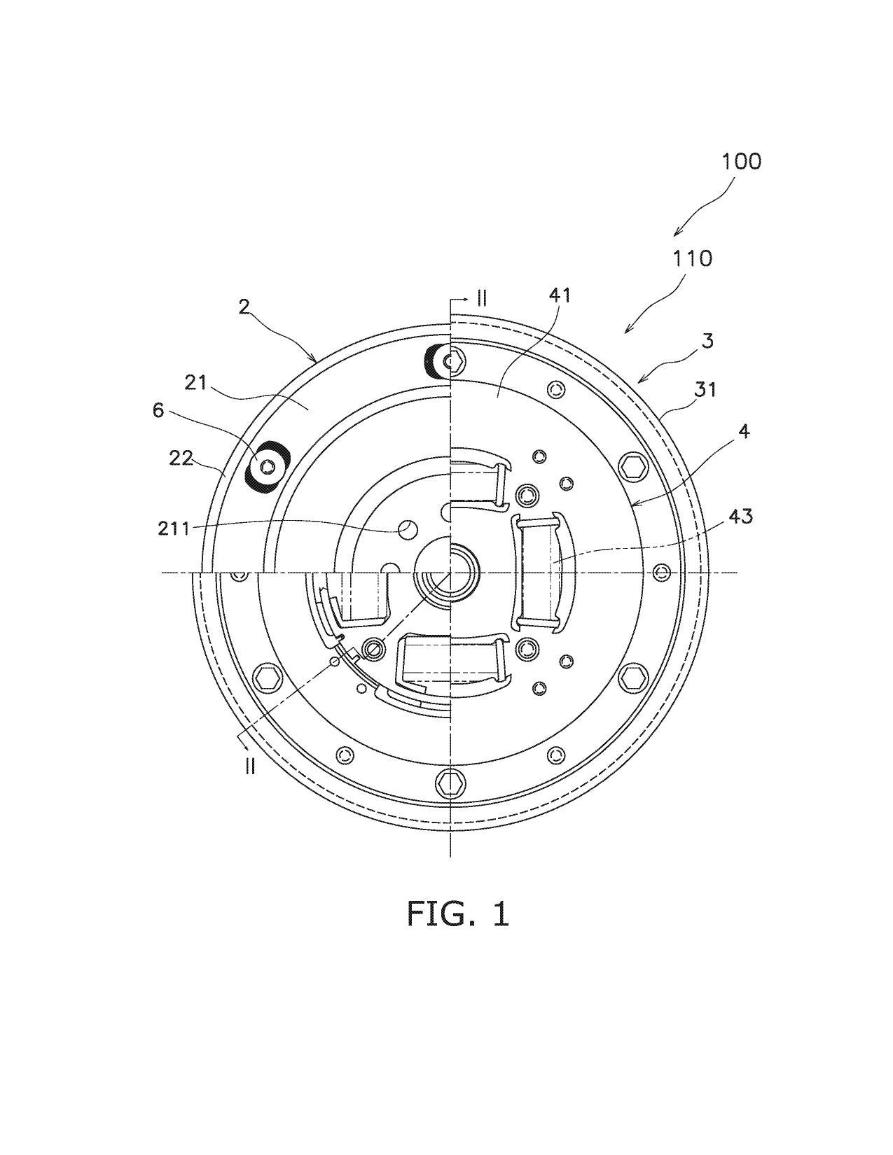

FIG. 1 is a front view of the power transmission device 100, whereas FIG. 2 is a cross-sectional view of the power transmission device 100 taken along line II-II in FIG. 1. As shown in FIGS. 1 and 2, the power transmission device 100 includes a drive plate 2, a vibration absorbing member 5, a plurality of inertia members 6, and a torque fluctuation inhibiting device 110. The torque fluctuation inhibiting device 110 includes a torque limiter 3 and a damper unit 4. The drive plate 2 and the torque limiter 3 are configured to be rotated unitarily with each other. The torque limiter 3 and the damper unit 4, albeit rotatable relative to each other, are basically rotated unitarily with each other. When a torque transmitted to the power transmission device 100 exceeds a predetermined value, the torque limiter 3 and the damper unit 4 are rotated relative to each other.

The power transmission device 100 is installed between a prime mover (omitted in illustration) and an output-side member (omitted in illustration). It should be noted that the prime mover refers to, for instance, an internal combustion engine. On the other hand, the output-side member refers to, for instance, an electric motor, a transmission, or so forth. The internal combustion engine is disposed on the second side (the left side in FIG. 2) of the power transmission device 100 in the axial direction, whereas the output-side member is disposed on the first side (the right side in FIG. 2) of the power transmission device 100 in the axial direction. The power transmission device 100 is configured to limit a torque transmitted between the internal combustion engine and the output-side member and attenuate fluctuations in torque.

### Drive Plate

The drive plate 2 is configured to receive a torque outputted from the prime mover. Specifically, the drive plate 2 is attached to a crankshaft 102 by a plurality of bolts 101. The drive plate 2 has a disc shape.

The drive plate 2 includes a disc portion 21 and a first cylindrical portion 22. The disc portion 21 is configured to be attached to the crankshaft 102. Specifically, the disc portion 21 includes a plurality of through holes 211. The drive plate 2 is fastened to the crankshaft 102 by the bolts 101 through the through holes 211.

The first cylindrical portion 22 extends from the outer peripheral end of the disc portion 21 to the first side in the axial direction. The first cylindrical portion 22 is formed by bending an outer peripheral part of the drive plate 2. The drive plate 2 can be made of a steel plate or so forth; specifically, the drive plate 2 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The drive plate 2 can be formed by sheet metal processing or stamping of a steel plate. Specifically, the drive plate 2 can be formed by single-stage stamping, progressive stamping, or transfer stamping. Because of this, the first cylindrical portion 22 is substantially equal in plate thickness to the disc portion 21. It should be noted that the drive plate 2 can be set to have a plate thickness of, for instance, about 2.0 mm to 8.0 mm.

### Torque Fluctuation Inhibiting Device

The torque fluctuation inhibiting device 110 includes the torque limiter 3 and the damper unit 4. The torque fluctuation inhibiting device 110 is configured to inhibit fluctuations in torque. The torque fluctuation inhibiting device 110 is disposed on the first side of the drive plate 2 in the axial direction. The torque fluctuation inhibiting device 110 is configured to be attached to the drive plate 2.

### Torque Limiter

The torque limiter 3 is disposed to be rotatable about the rotational axis O. The torque limiter 3 is disposed on the first side of the drive plate 2 in the axial direction. The torque limiter 3 has an annular shape. The torque limiter 3 is configured to be attached to the drive plate 2.

The torque limiter 3 is configured to limit the torque transmitted between the drive plate 2 and the damper unit 4. In other words, the torque limiter 3 is configured to restrict transmission of the torque in the power transmission device 100 when the torque is greater than or equal to the predetermined value. The torque limiter 3 is disposed radially outside the damper unit 4.

The torque limiter 3 includes a first side plate 31, a second side plate 32, a friction plate 33, a pressure plate 34, and an urging member 35.

### First Side Plate

The first side plate 31 is disposed on the first side of the drive plate 2 in the axial direction. The first side plate 31 is attached to the drive plate 2. Specifically, the first side plate 31 is attached to the drive plate 2 through the inertia members 6 fixed to the drive plate 2.

A plurality of bolts 103 are screwed into a plurality of screw holes 61, each of which is provided in each of the inertia members 6, on a one-to-one correspondence, whereby the first and second side plates 31 and 32 are fixed to the inertia members 6. The first side plate 31 has an annular shape.

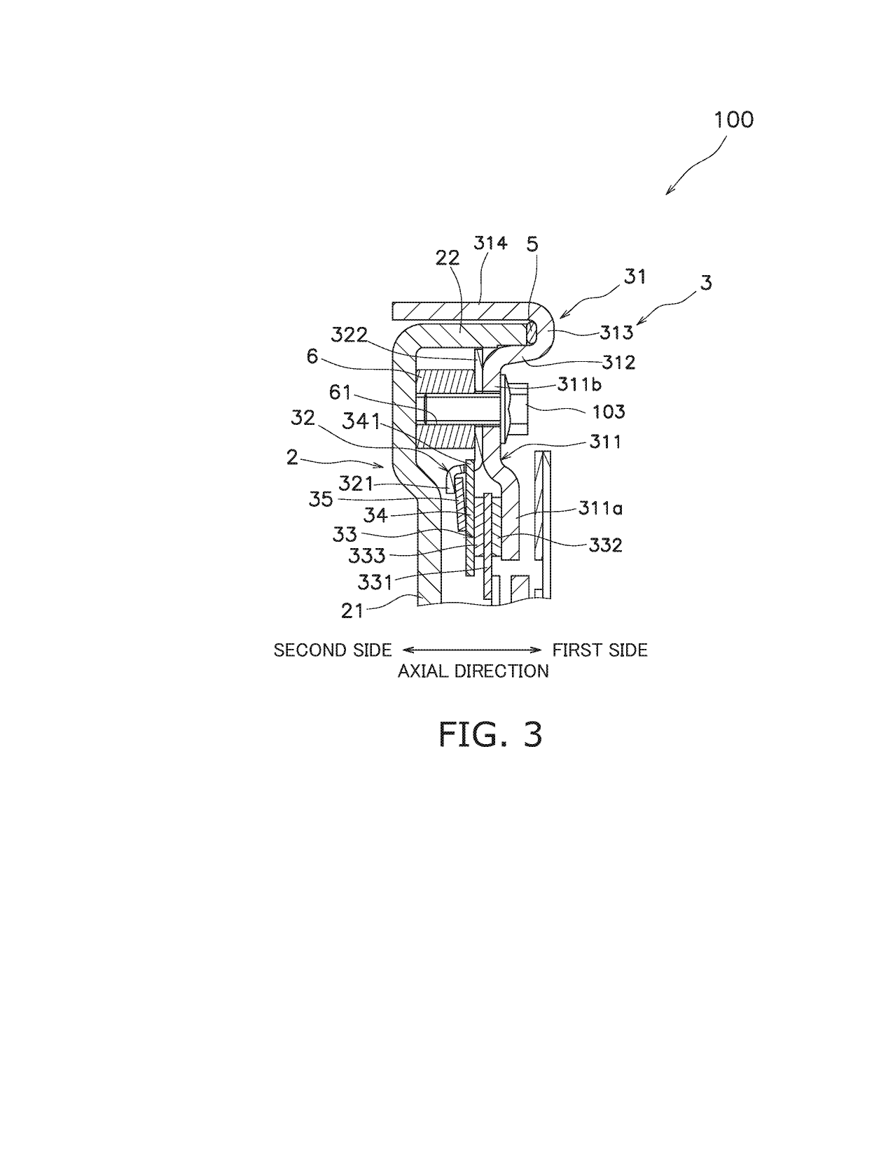

FIG. 3 is an enlarged cross-sectional view of the power transmission device 100. As shown in FIG. 3, the first side plate 31 includes an annular portion 311, a second cylindrical portion 312, a coupling portion 313, and a third cylindrical portion 314. The annular portion 311, the second cylindrical portion 312, the coupling portion 313, and the third cylindrical portion 314 are integrated as a single member.

The annular portion 311 is made in the shape of an annulus extending in the circumferential direction. The annular portion 311 includes a first inner peripheral portion 311a and a first outer peripheral portion 311b. The first inner peripheral portion 311a is in contact with the friction plate 33. The first inner peripheral portion 311a is disposed on the first side of the first outer peripheral portion 311b in the axial direction. The first outer peripheral portion 311b is disposed radially outside the first inner peripheral portion 311a. The first outer peripheral portion 311b overlaps with the inertia members 6 as seen in the axial direction.

The second cylindrical portion 312 extends from the outer peripheral end of the annular portion 311 in the axial direction. When described in detail, the second cylindrical portion 312 extends from the outer peripheral end of the annular portion 311 to the first side in the axial direction. In other words, the second cylindrical portion 312 extends from the outer peripheral end of the annular portion 311 in the axial direction so as to separate from the drive plate 2. The second cylindrical portion 312 extends in a direction identical to extension of the first cylindrical portion 22. The second cylindrical portion 312 is disposed radially inside the first cylindrical portion 22. The first cylindrical portion 22 overlaps with the second cylindrical portion 312 as seen in the radial direction. When described in detail, the first cylindrical portion 22 overlaps at the distal end thereof with the second cylindrical portion 312 as seen in the radial direction.

The coupling portion 313 extends radially outward from the distal end of the second cylindrical portion 312. When described in detail, the coupling portion 313 extends radially outward from the axially first side end of the second cylindrical portion 312. The coupling portion 313 is made in the shape of an annulus extending in the circumferential direction. The coupling portion 313 couples the second and third cylindrical portions 312 and 314 therethrough to each other. The coupling portion 313 overlaps with the first cylindrical portion 22 as seen in the axial direction. The coupling portion 313 is disposed away from the first cylindrical portion 22 at an interval in the axial direction.

The third cylindrical portion 314 extends from the outer peripheral end of the coupling portion 313 to the second side in the axial direction. In other words, an outer peripheral part of the first side plate 31 is bent to the first side in the axial direction, whereby the second cylindrical portion 312 is formed; then, an outer peripheral part of the second cylindrical portion 312 is further folded to the second side in the axial direction, whereby the third cylindrical portion 314 is formed. Because of this, the third cylindrical portion 314, the annular portion 311, the second cylindrical portion 312, and the coupling portion 313 are substantially equal in plate thickness. It should be noted that the first side plate 31 can be set to have a plate thickness of, for instance, about 2.0 mm to 8.0 mm.

The third cylindrical portion 314 is disposed radially outside the second cylindrical portion 312. The third cylindrical portion 314 is disposed radially away from the second cylindrical portion 312 at an interval. The first cylindrical portion 22 is disposed radially between the second and third cylindrical portions 312 and 314. When described in detail, the distal end of the first cylindrical portion 22 is disposed radially between the second and third cylindrical portions 312 and 314. The first, second, and third cylindrical portions 22, 312, and 314 overlap with each other as seen in the radial direction. The third cylindrical portion 314 is larger in length than the first cylindrical portion 22. The third cylindrical portion 314 covers the entirety of the outer peripheral surface of the first cylindrical portion 22.

The inner peripheral surface of the first cylindrical portion 22 is in contact with the outer peripheral surface of the second cylindrical portion 312. In this case, the outer peripheral surface of the second cylindrical portion 312 corresponds to “a contact surface” of the present invention. The outer peripheral surface of the first cylindrical portion 22 is herein disposed away from the inner peripheral surface of the third cylindrical portion 314 at the interval, but alternatively, may be in contact therewith. When the outer peripheral surface of the first cylindrical portion 22 is thus in contact with the inner peripheral surface of the third cylindrical portion 314, the inner peripheral surface of the first cylindrical portion 22 may be disposed away from the outer peripheral surface of the second cylindrical portion 312 at an interval.

The first side plate 31 can be made of a steel plate or so forth; specifically, the first side plate 31 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The second cylindrical portion 312, the coupling portion 313, and the third cylindrical portion 314 can be formed by bending the outer peripheral part of the first side plate 31 in the axial direction. The first side plate 31 can be formed by sheet metal processing or stamping of a steel plate. Specifically, the first side plate 31 can be formed by single-stage stamping, progressive stamping, or transfer stamping.

### Second Side Plate

The second side plate 32 is disposed on the second side of the first side plate 31 in the axial direction. In other words, the second side plate 32 is disposed axially between the drive plate 2 and the first side plate 31. When described in detail, the second side plate 32 is disposed in a space defined by the disc portion 21, the first cylindrical portion 22, and the annular portion 311.

The friction plate 33, the pressure plate 34, and the urging member 35 are disposed axially between the first and second side plates 31 and 32. The second side plate 32 is smaller in plate thickness than the first side plate 31.

The second side plate 32 is configured to be rotated unitarily with the first side plate 31. The second side plate 32 is fastened to the first side plate 31 by a plurality of fastening members 37 (see FIG. 2). The fastening members 37 are disposed at intervals in the circumferential direction. The fastening members 37 are, for instance, rivets. The first and second side plates 31 and 32, thus fastened to each other by the fastening members 37, are fixed to the inertia members 6 by the bolts 103.

The second side plate 32 includes a second inner peripheral portion 321 and a second outer peripheral portion 322. The second inner peripheral portion 321 supports the urging member 35. The second inner peripheral portion 321 is disposed on the second side of the second outer peripheral portion 322 in the axial direction. The second inner peripheral portion 321 is disposed away from the first inner peripheral portion 311a at an interval in the axial direction. The friction plate 33, the pressure plate 34, and the urging member 35 are disposed axially between the first and second inner peripheral portions 311a and 321.

The second outer peripheral portion 322 is disposed radially outside the second inner peripheral portion 321. The second outer peripheral portion 322 is in contact with the first outer peripheral portion 311b in the axial direction. The second outer peripheral portion 322 is held by the first outer peripheral portion 311b and the inertia members 6, while being axially interposed therebetween.

The outer peripheral surface of the second side plate 32 is opposed to the inner peripheral surface of the first cylindrical portion 22. The outer peripheral surface of the second side plate 32 may be in contact with the inner peripheral surface of the first cylindrical portion 22, or alternatively, may be disposed away therefrom at an interval.

### Friction Plate

As shown in FIGS. 2 and 3, the friction plate 33 is a plate made in the shape of an annulus extending in the circumferential direction. The friction plate 33 is disposed to be rotatable about the rotational axis O. The friction plate 33 is disposed to be rotatable relative to the first side plate 31.

The friction plate 33 is in contact with the first side plate 31 in the axial direction. When described in detail, the friction plate 33 is in contact with the first inner peripheral portion 311a of the annular portion 311 in the axial direction. The friction plate 33 is configured to be engaged by friction with the first side plate 31.

The friction plate 33 is attached to a first rotary member 41 of the damper unit 4 (to be described). When described in detail, the friction plate 33 is attached to a second plate 41b. For example, the friction plate 33 is attached to the second plate 41b by a plurality of fastening members 104. The friction plate 33 is rotated unitarily with the first rotary member 41. It should be noted that the friction plate 33 is provided as a discrete member separated from the second plate 41b; alternatively, the friction plate 33 may be integrated with the second plate 41b as a single member.

The friction plate 33 includes a plate body 331, a first friction material 332, and a second friction material 333. The plate body 331 is made in the shape of an annulus extending in the circumferential direction. The first friction material 332 is attached to the axially first side one of the surfaces of the plate body 331. The second friction material 333 is attached to the axially second side one of the surfaces of the plate body 331. The first and second friction materials 332 and 333 are rotated unitarily with the plate body 331. Each of the first and second friction materials 332 and 333 has an annular shape. The first and second friction materials 332 and 333 are attached to an outer peripheral part of the plate body 331.

### Pressure Plate

The pressure plate 34 has an annular shape. The pressure plate 34 is disposed axially between the urging member 35 and the friction plate 33. The pressure plate 34 holds the friction plate 33 in cooperation with the first side plate 31, with the friction plate 33 interposed therebetween. The pressure plate 34 is in contact with the second friction material 333, while the first side plate 31 is in contact with the first friction material 332.

The pressure plate 34 is configured to be rotated unitarily with the first side plate 31. It should be noted that the pressure plate 34 is axially movable with respect to the first side plate 31. Specifically, the pressure plate 34 includes a plurality of protruding portions 341 protruding radially outward. The protruding portions 341 are engaged with a plurality of engaging holes provided in the second side plate 32, respectively, whereby the pressure plate 34 is rotated unitarily with the second side plate 32, while being axially movable with respect thereto. The second side plate 32 is rotated unitarily with the first side plate 31, while being axially immovable with respect thereto; hence, the pressure plate 34 is rotated unitarily with the first side plate 31, while being axially movable with respect thereto.

### Urging Member

The urging member 35 is disposed axially between the second side plate 32 and the pressure plate 34. The urging member 35 urges the pressure plate 34 to the first side in the axial direction. In other words, the urging member 35 urges the pressure plate 34 toward the first side plate 31. Accordingly, the friction plate 33 is held by the pressure plate 34 and the first side plate 31, while being interposed therebetween. The urging member 35 is made in the shape of an annulus extending in the circumferential direction. The urging member 35 is, for instance, a disc spring. The urging member 35 is in contact at the outer peripheral end thereof with the second inner peripheral portion 321, while being in contact at the inner peripheral end thereof with the pressure plate 34.

### Vibration Absorbing Member

The vibration absorbing member 5 is disposed axially between the coupling portion 313 and the first cylindrical portion 22. When described in detail, the vibration absorbing member 5 is disposed in a space defined by the first cylindrical portion 22, the second cylindrical portion 312, the coupling portion 313, and the third cylindrical portion 314. The vibration absorbing member 5 is made in the shape of an annulus extending in the circumferential direction. The vibration absorbing member 5 is, for instance, an O-ring. The vibration absorbing member 5 is being compressed in the axial direction.

### Inertia Member

The inertia members 6 are disposed on the first side of the drive plate 2 in the axial direction. The inertia members 6 are disposed on the second side of the first side plate 31 in the axial direction. The inertia members 6 are configured to be rotated unitarily with the drive plate 2. Specifically, the inertia members 6 are fixed to the drive plate 2 by welding. The inertia members 6 are fixed to the outer peripheral part of the drive plate 2. The inertia members 6 are disposed away from each other at intervals in the circumferential direction.

Each inertia member 6 overlaps with the first cylindrical portion 22 and the third cylindrical portion 314 as seen in the radial direction. When described in detail, each inertia member 6 is opposed to the inner peripheral surface of the first cylindrical portion 22. Each inertia member 6 overlaps with the annular portion 311 as seen in the axial direction. When described in detail, each inertia member 6 overlaps with the first outer peripheral portion 311b as seen in the axial direction.

Each inertia member 6 overlaps with the second side plate 32 as seen in the axial direction. When described in detail, each inertia member 6 overlaps with the second outer peripheral portion 322 as seen in the axial direction. Each inertia member 6 is opposed to the second outer peripheral portion 322. It should be noted that another member may be interposed between each inertia member 6 and the second outer peripheral portion 322.

Each inertia member 6 is disposed axially between the drive plate 2 and the first side plate 31. When described in detail, each inertia member 6 is sandwiched axially between the drive plate 2 and the second side plate 32. When described in more detail, each inertia member 6 is sandwiched axially between the disc portion 21 and the second outer peripheral portion 322.

Each inertia member 6 is, for instance, a nut. Each inertia member 6 has a thickness larger than the plate thickness of the first side plate 31. Also, the thickness of each inertia member 6 is larger than the plate thickness than the drive plate 2. It should be noted that the thickness of each inertia member 6 means the axial dimension thereof.

Each inertia member 6 includes the screw hole 61 extending in the axial direction. The screw hole 61 opens to the first side in the axial direction. It should be noted that in the present preferred embodiment, the screw hole 61 penetrates each inertia member 6 in the axial direction; hence, the screw hole 61 opens to the second side as well in the axial direction. Each bolt 103 is screwed into the screw hole 61 of each inertia member 36. Accordingly, the first and second side plates 31 and 32 are attached to the drive plate 2 through the inertia members 6.

### Damper Unit

The damper unit 4 is attached to the torque limiter 3. The damper unit 4 is configured to attenuate fluctuations in rotation. The damper unit 4 includes the first rotary member 41, a second rotary member 42, and a plurality of elastic members 43.

### First Rotary Member

The first rotary member 41 is rotated unitarily with the friction plate 33 of the torque limiter 3. The first rotary member 41 includes a first plate 41a and the second plate 41b. Each of the first and second plates 41a and 41b is an annular member including a center hole. The first and second plates 41a and 41b are rotated unitarily with each other. Besides, the first and second plates 41a and 41b are axially immovable relative to each other. The first and second plates 41a and 41b are fastened to each other by a plurality of fastening members 106.

The first and second plates 41a and 41b are disposed away from each other at an interval in the axial direction. The second plate 41b is disposed on the second side of the first plate 41a in the axial direction.

The first plate 41a includes a plurality of window portions 411a, while the second plate 41b includes a plurality of window portions 411b. It should be noted that in the present preferred embodiment, the first plate 41a includes four window portions 411a, while the second plate 41b includes four window portions 411b; however, the window portions 411a, 411b are not limited in number to this.

Not only the window portions 411a but also the window portions 411b are disposed away from each other at intervals in the circumferential direction. Not only the window portions 411a but also the window portions 411b are configured to accommodate the elastic members 43, respectively.

The outer peripheral edge of the first rotary member 41 is disposed radially outside that of the friction plate 33. In other words, the first rotary member 41 is larger in outer diameter than the friction plate 33. The first rotary member 41 overlaps at an outer peripheral part thereof with friction surfaces, at which the friction plate 33 and the first side plate 31 are in contact with each other, as seen in the axial direction. The outer peripheral part of the first rotary member 41 is disposed on the first side of the torque limiter 3 in the axial direction.

### Second Rotary Member

The second rotary member 42 is configured to transmit the torque, inputted thereto from the first rotary member 41, to the output-side member. The second rotary member 42 is disposed axially between the first and second plates 41a and 41b. The second rotary member 42 is disposed to be rotatable relative to the first and second plates 41a and 41b.

The second rotary member 42 includes a hub 421 and a flange plate 422. The hub 421 and the flange plate 422 are separated as different members but may be integrated as a single member.

The hub 421 has a tubular shape and extends in the axial direction. The hub 421 is disposed in the center hole of the first plate 41a and that of the second plate 41b. The hub 421 is provided with a spline hole, extending in the axial direction, in an inner peripheral part thereof. The spline hole enables an input shaft of the output-side member to be spline-coupled thereto.

The flange plate 422 radially extends from the outer peripheral surface of the hub 421. The flange plate 422 has an annular shape. The flange plate 422 is disposed to be rotatable relative to the first and second plates 41a and 41b. The flange plate 422 is disposed axially between the first and second plates 41a and 41b.

The flange plate 422 includes a plurality of accommodation holes 423. It should be noted that in the present preferred embodiment, the flange plate 422 includes four accommodation holes 423; however, the accommodation holes 423 are not limited in number to this. The accommodation holes 423 are disposed away from each other at intervals in the circumferential direction. The accommodation holes 423 are configured to accommodate the elastic members 43, respectively. The accommodation holes 423 are disposed to overlap with not only the window portions 411a but also the window portions 411b, respectively, as seen in the axial direction.

### Elastic Members

The elastic members 43 are configured to elastically couple the first and second rotary members 41 and 42 therethrough to each other in a rotational direction. The elastic members 43 are, for instance, coil springs.

The elastic members 43 are accommodated in the accommodation holes 423 of the second rotary member 42, respectively. In addition, the elastic members 43 are accommodated in not only the window portions 411a of the first plate 41a but also the window portions 411b of the second plate 41b, respectively. The elastic members 43 are disposed radially inside the torque limiter 3.

### Modifications

One preferred embodiment of the present invention has been explained above. However, the present invention is not limited to the above, and it will be apparent to one of ordinary skill in the art from this disclosure that a variety of changes can be made without departing from the gist of the present invention. It should be noted that basically speaking, respective modifications to be described are applicable separately or in combination in an embodiment.

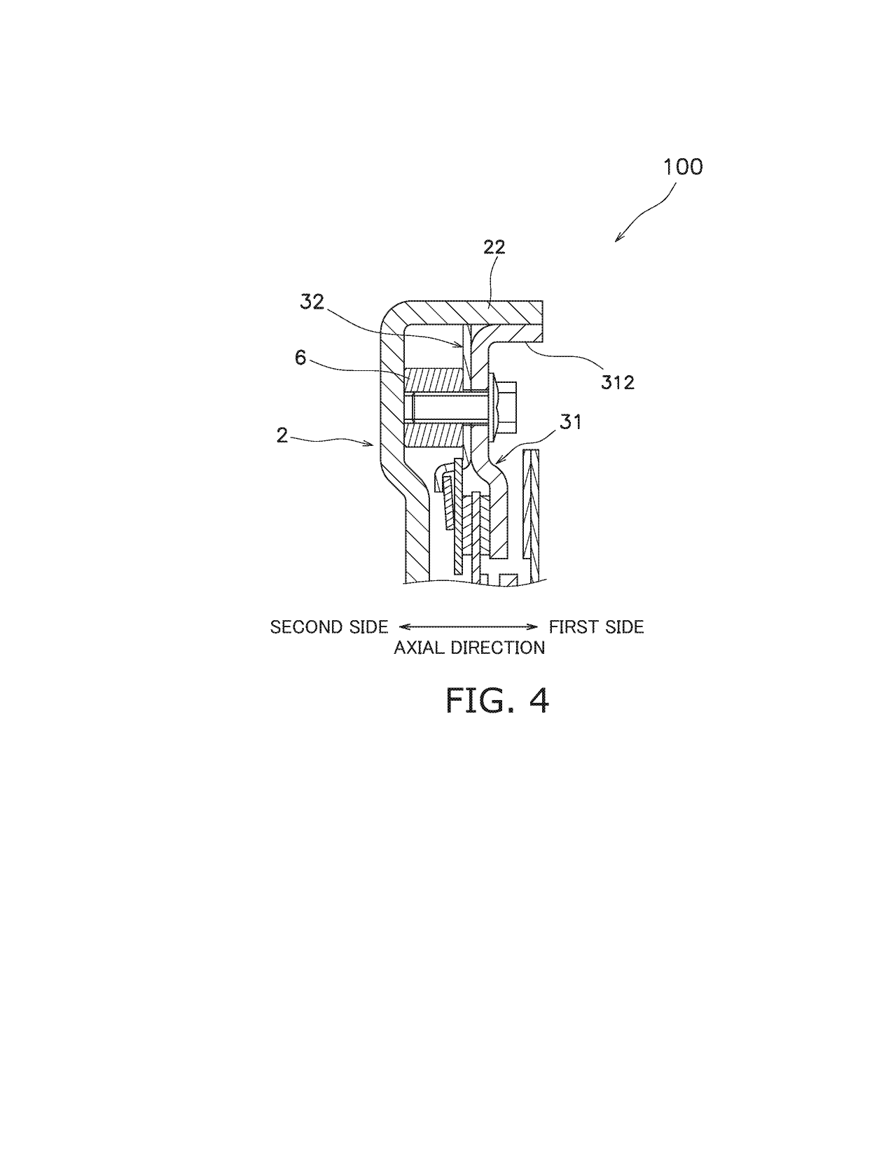

(a) In the preferred embodiment described above, the first side plate 31 includes the second cylindrical portion 312, the coupling portion 313, and the third cylindrical portion 314; however, the first side plate 31 is not limited in configuration to this. For example, as shown in FIG. 4, the first side plate 31 may not include the coupling portion 313 and the third cylindrical portion 314. In other words, the second cylindrical portion 312 may be provided as the outer peripheral end of the first side plate 31. It should be noted that the first side plate 31 may not include the second cylindrical portion 312 as well.

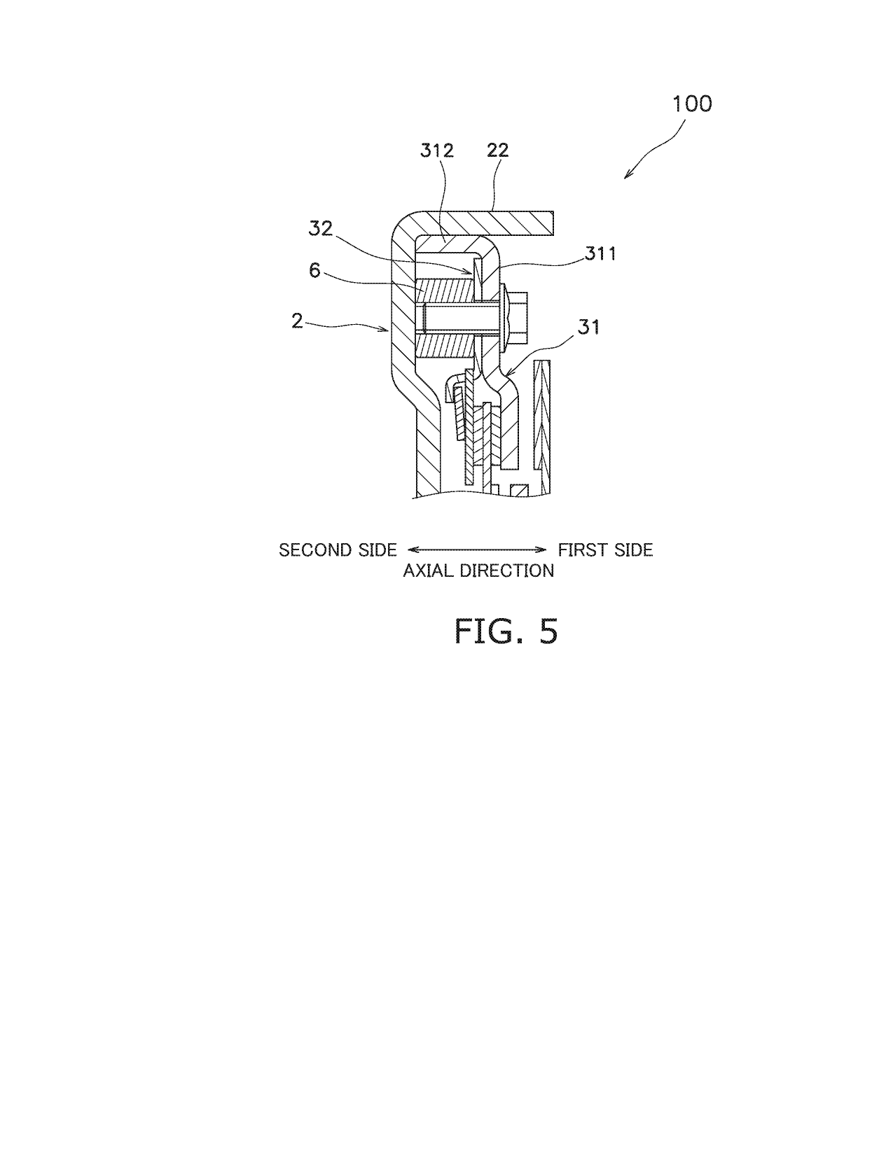

(b) In the preferred embodiment described above, the second cylindrical portion 312 of the first side plate 31 extends from the annular portion 311 to the first side in the axial direction; however, the first side plate 31 is not limited in configuration to this. For example, as shown in FIG. 5, the second cylindrical portion 312 of the first side plate 31 may extend from the annular portion 311 to the second side in the axial direction. In this modification, the first cylindrical portion 22 may be disposed radially inside the second cylindrical portion 312. In addition, the outer peripheral surface of the first cylindrical portion 22 may be in contact with the inner peripheral surface of the second cylindrical portion 312.

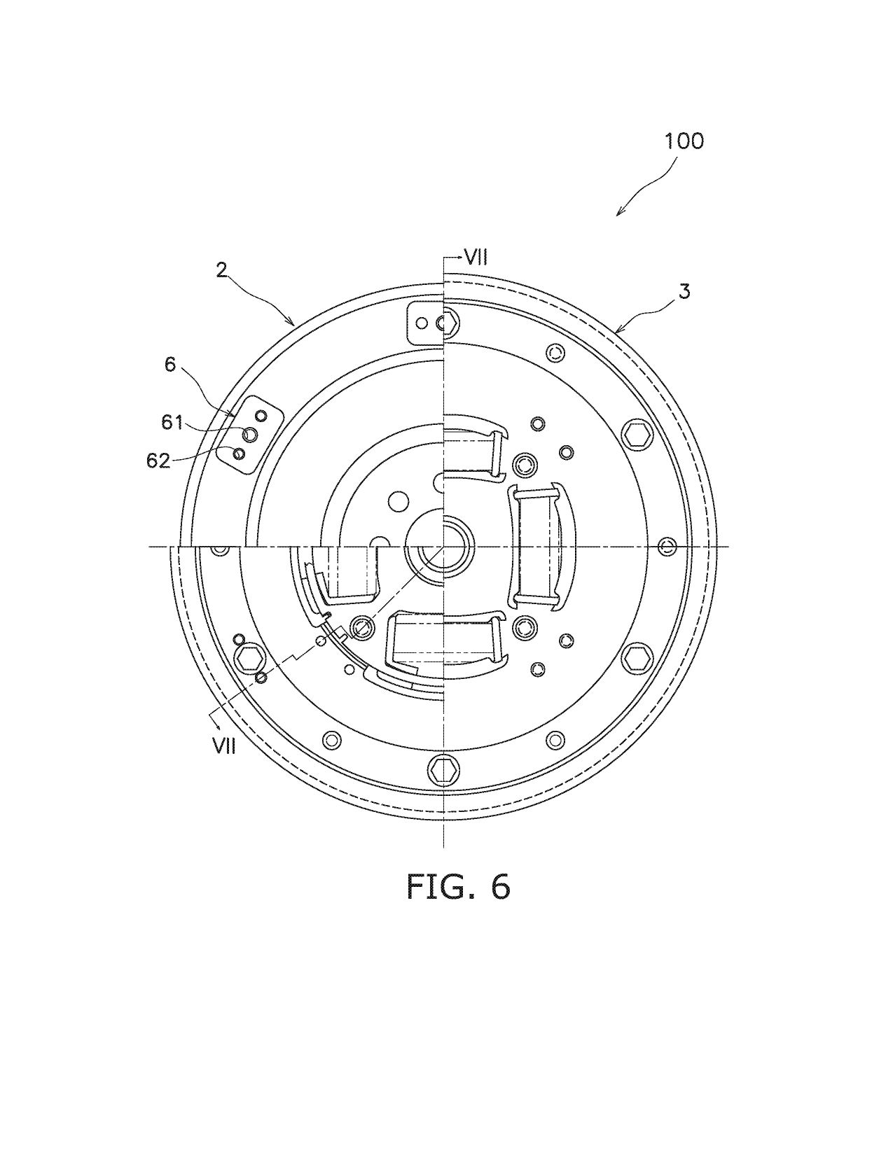

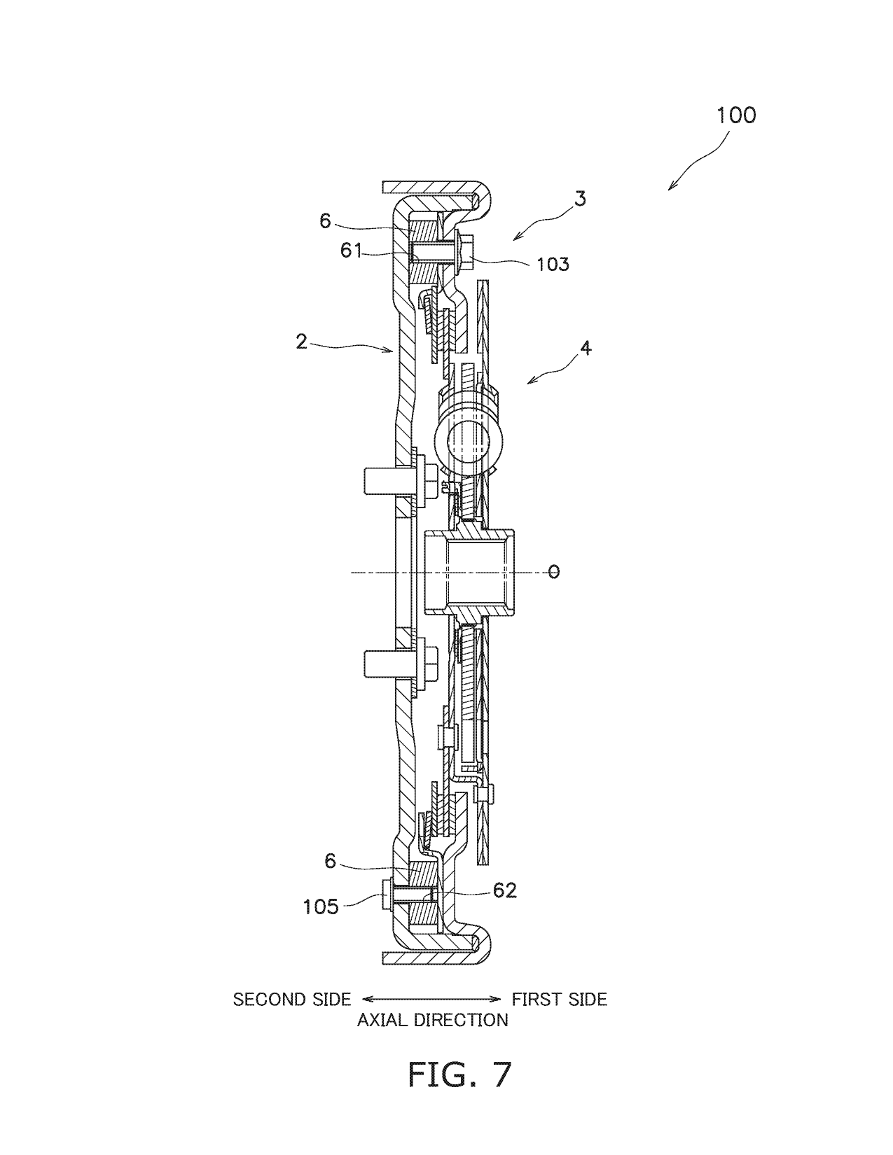

(c) In the preferred embodiment described above, the inertia members 6 are fixed to the drive plate 2 by welding; however, the method for fixing the inertia members 6 is not limited to welding. For example, as shown in FIGS. 6 and 7, the inertia members 6 may be fixed to the drive plate 2 by a plurality of bolts 105. Specifically, each inertia member 6 includes at least one first screw hole 61 and at least one second screw hole 62. It should be noted that in the present modification, each inertia member 6 includes one first screw hole 61 and two second screw holes 62. The first screw hole 61 and each second screw hole 62 may be identical in hole diameter to each other or alternatively may be different in hole diameter from each other. Two bolts 105 are screwed into the second screw holes 62, whereby each inertia member 6 is fixed to the drive plate 2. On the other hand, one bolt 103 is fixed to the first screw hole 61, whereby each inertia member 6 is fixed to the first side plate 31. As a result, the first side plate 31 is fixed to the drive plate 2 through the inertia members 6.

(d) In the preferred embodiment described above, the second side plate 32 is disposed on the second side of the first side plate 31 in the axial direction; however, the torque limiter 3 is not limited in configuration to this. For example, the second side plate 32 may be disposed on the first side of the first side plate 31 in the axial direction.

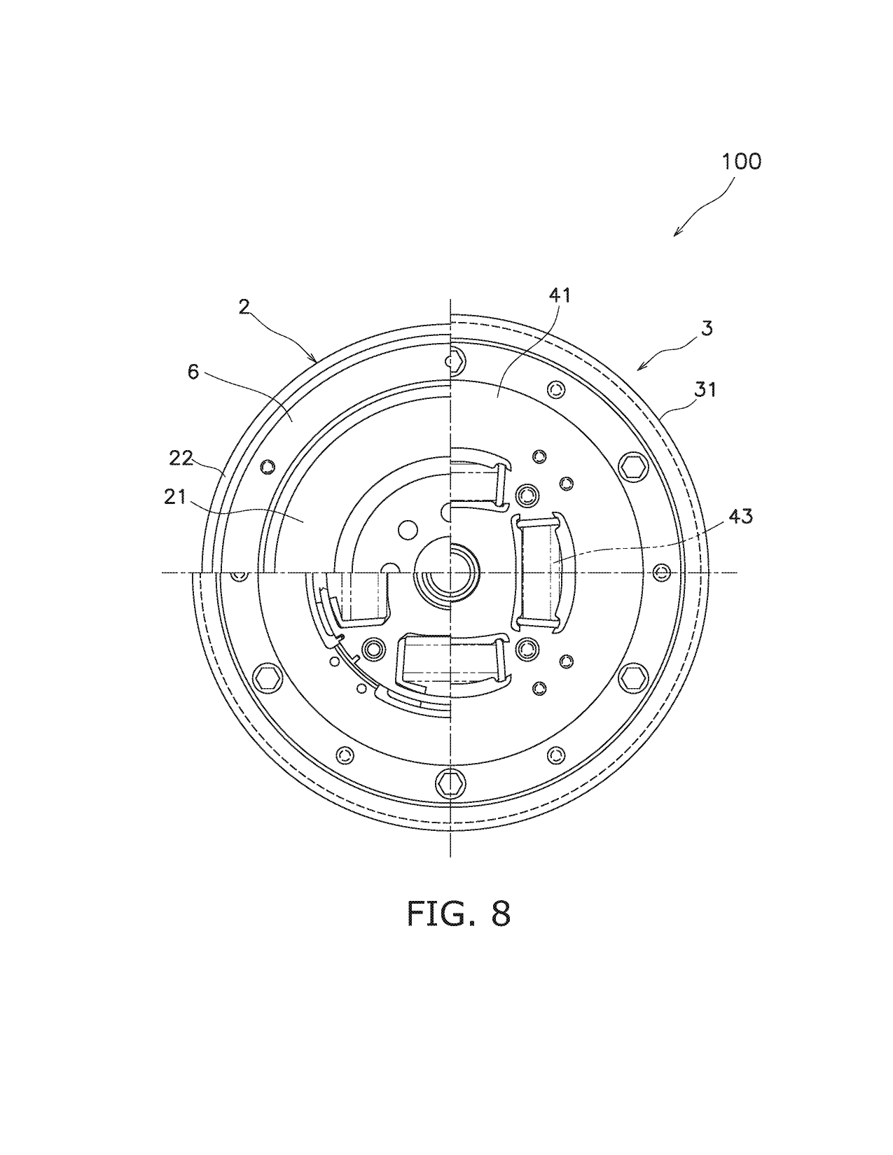

(e) In the preferred embodiment described above, the multiple nuts are provided as the multiple inertia members 6; however, the inertia members 6 are not limited in configuration to this. For example, as shown in FIG. 8, a single member, made in the shape of an annulus extending in the circumferential direction, may be provided as only one inertia member 6. The inertia member 6 is larger in plate thickness than the first side plate 31. In addition, the inertia member 6 is larger in plate thickness than the drive plate 2.

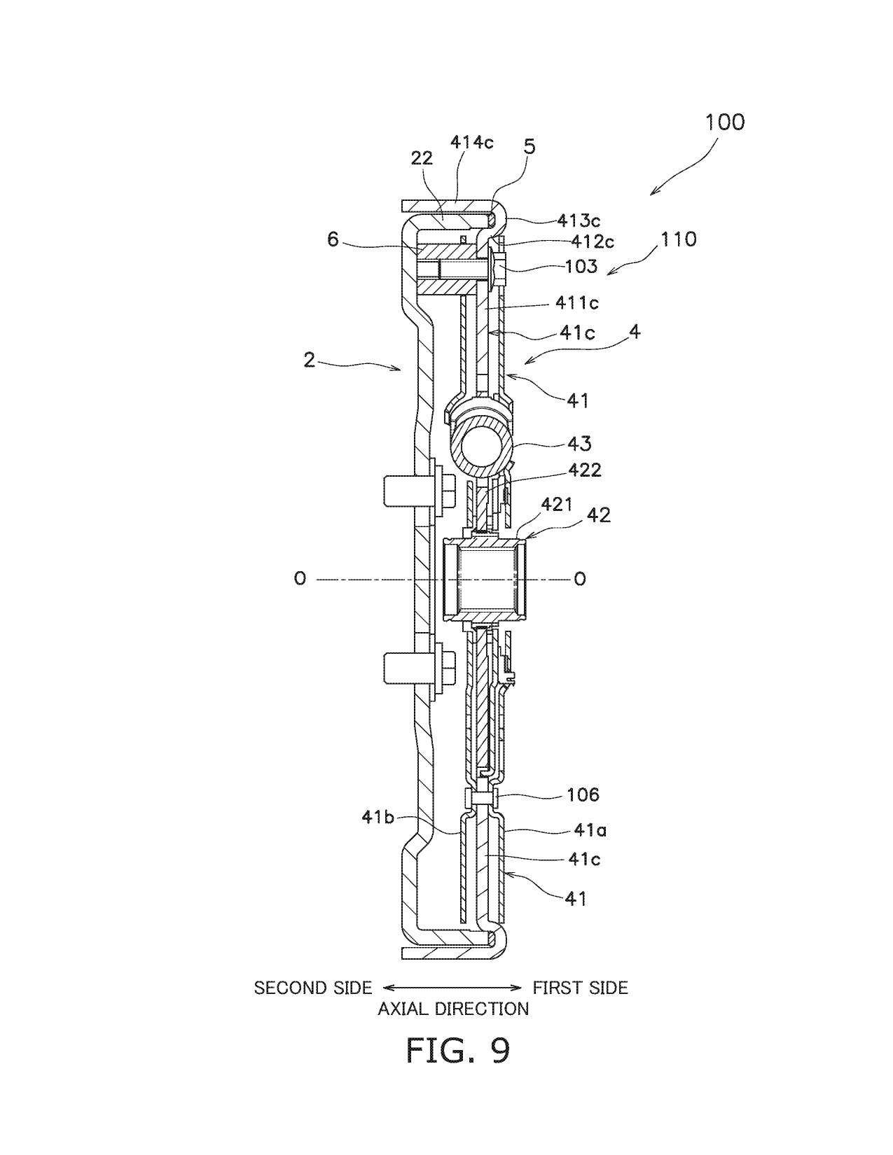

(f) In the preferred embodiment described above, the torque fluctuation inhibiting device 110 includes the torque limiter 3 and the damper unit 4; however, the torque fluctuation inhibiting device 110 is not limited in configuration to this. For example, as shown in FIG. 9, the torque fluctuation inhibiting device 110 may not include the torque limiter 3. In this case, the damper unit 4 is attached to the drive plate 2. The first rotary member 41 of the damper unit 4 is herein attached to the inertia members 6 by the bolts 103.

The first rotary member 41 includes not only the first and second plates 41a and 41b but also an attachment plate 41c. The attachment plate 41c is attached to the inertia members 6 by the bolts 103.

The attachment plate 41c is disposed axially between the first and second plates 41a and 41b. The attachment plate 41c is configured to be rotated unitarily with the first and second plates 41a and 41b. The attachment plate 41c is fastened to the first and second plates 41a and 41b by the fastening members 106. The attachment plate 41c is made in shape of an annulus extending in the circumferential direction.

The attachment plate 41c includes an annular portion 411c, a second cylindrical portion 412c, a coupling portion 413c, and a third cylindrical portion 414c. It should be noted that the annular portion 411c, the second cylindrical portion 412c, the coupling portion 413c, and the third cylindrical portion 414c of the attachment plate 41c correspond to the annular portion 311, the second cylindrical portion 312, the coupling portion 313, and the third cylindrical portion 314 of the first side plate 31 described above, respectively; hence, the detailed explanation thereof will be hereinafter omitted. The inner peripheral surface of the first cylindrical portion 22 is in contact with the outer peripheral surface of the second cylindrical portion 412c. In this case, the outer peripheral surface of the second cylindrical portion 412c corresponds to “the contact surface” of the present invention.

The attachment plate 41c is disposed to overlap with the flange plate 422 as seen in the radial direction. The attachment plate 41c can be set to be equal in plate thickness to the flange plate 422. For example, the flange plate 422 and the attachment plate 41c can be produced by being taken out from a sheet of plate.

It should be noted that the torque fluctuation inhibiting device 110 may include only the torque limiter 3 without including the damper unit 4.

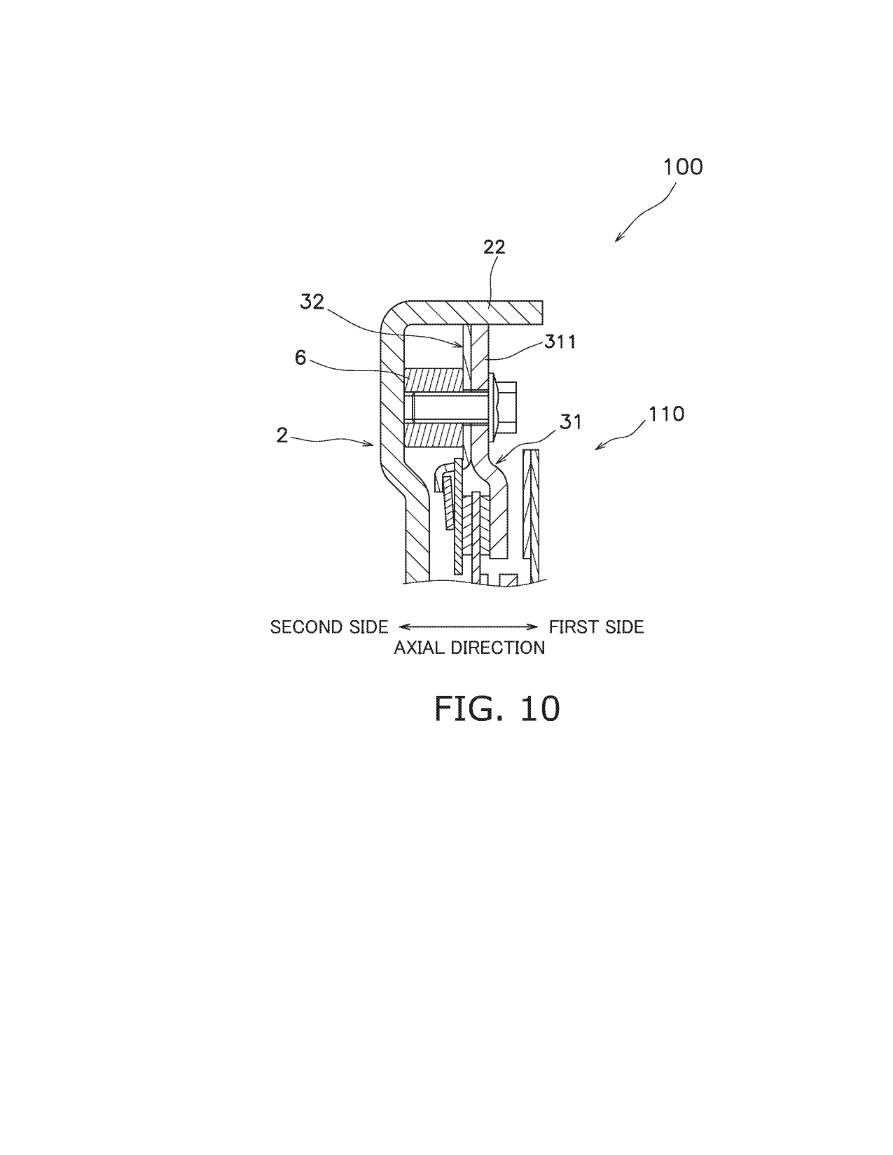

(g) As shown in FIG. 10, the torque fluctuation inhibiting device 110 may not include the second cylindrical portion 312. In this case, the outer peripheral surface of the annular portion 311 is in contact with the inner peripheral surface of the first cylindrical portion 22. In other words, the outer peripheral surface of the annular portion 311 corresponds to “the contact surface” of the present invention.

### LIST OF REFERENCE NUMERALS

2: Drive plate,

21:Disc portion,

22: First cylindrical portion,

3: Torque limiter,

31: First side plate,

311: Annular portion,

312: Second cylindrical portion,

313: Coupling portion,

314; Third cylindrical portion,

32: Second side plate,

33: Friction plate,

34: Pressure plate,

35: Urging member,

4: Damper unit,

41: First rotary member,

42: Second rotary member,

43: Elastic member,

5: Vibration absorbing member,

6: Inertia member,

61: Screw hole,

100: Power transmission device

110: Torque fluctuation inhibiting device.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “plurality,” as used herein, can encompass the configuration in which each element of a plurality of elements has a different shape or structure from each other in addition to the configuration in which the plurality of elements have the same shapes or structures as each other.

The terms “a” (or “an”), “one or more” and “at least one” can be used interchangeably herein. The phrase “at least one of” as used in this disclosure means “one or more” of a desired choice.

Terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Modifications and variations of the present invention will be apparent to one of ordinary skill in the art in light of this disclosure. It is therefore to be understood that within the scope of the appended claims, the invention may be practiced otherwise than as specifically described herein.

1. A power transmission device comprising:
a drive plate configured to receive a torque outputted from a prime mover; and
a torque fluctuation inhibiting device disposed on a first side of the drive plate in an axial direction, the torque fluctuation inhibiting device configured to be attached to the drive plate,
the drive plate including a disc portion and a first cylindrical portion, the first cylindrical portion extending from an outer peripheral end of the disc portion to the first side in the axial direction.

2. The power transmission device according to claim 1, wherein
the torque fluctuation inhibiting device includes a contact surface oriented radially outward, and
the contact surface is in contact with an inner peripheral surface of the first cylindrical portion.

3. The power transmission device according to claim 1, wherein
the torque fluctuation inhibiting device includes an annular portion and a second cylindrical portion, the annular portion extending in a circumferential direction, the second cylindrical portion extending from an outer peripheral end of the annular portion in the axial direction, and
the first cylindrical portion overlaps with the second cylindrical portion as seen in a radial direction.

4. The power transmission device according to claim 3, wherein the first cylindrical portion is disposed radially outside the second cylindrical portion.

5. The power transmission device according to claim 4, wherein an inner peripheral surface of the first cylindrical portion is in contact with an outer peripheral surface of the second cylindrical portion.

6. The power transmission device according to claim 3, wherein the second cylindrical portion extends from the outer peripheral end of the annular portion to the first side in the axial direction.

7. The power transmission device according to claim 6, wherein
the torque fluctuation inhibiting device includes a coupling portion and a third cylindrical portion, the coupling portion extending radially outward from a distal end of the second cylindrical portion, the third cylindrical portion extending from an outer peripheral end of the coupling portion to a second side in the axial direction, and
the first cylindrical portion is disposed radially between the second and third cylindrical portions.

8. The power transmission device according to claim 7, further comprising:
a vibration absorbing member disposed axially between the coupling portion and the first cylindrical portion.

9. The power transmission device according to claim 1, further comprising:
an inertia member configured to be rotated unitarily with the drive plate.

10. The power transmission device according to claim 9, wherein the inertia member is disposed axially between the drive plate and the torque fluctuation inhibiting device.

11. The power transmission device according to claim 9, wherein the inertia member is disposed to overlap with the first cylindrical portion as seen in a radial direction.

12. The power transmission device according to claim 9, wherein the inertia member includes a screw hole extending in the axial direction.

13. The power transmission device according to claim 9, wherein the inertia member is a nut with a thickness larger than a plate thickness of the drive plate.

14. The power transmission device according to claim 9, wherein
the inertia member is made in shape of an annulus extending in a circumferential direction, and
the inertia member is larger in plate thickness than the drive plate.

15. The power transmission device according to claim 1, wherein
the torque fluctuation inhibiting device includes at least either of a torque limiter and a damper unit,
the torque limiter includes
a first side plate configured to be rotated unitarily with the drive plate,
a friction plate disposed to be rotatable relative to the first side plate,
a pressure plate holding the friction plate in cooperation with the first side plate, with the friction plate interposed therebetween, and
an urging member urging the pressure plate toward the first side plate in the axial direction, and
the damper unit includes
a first rotary member,
a second rotary member disposed to be rotatable relative to the first rotary member, and
an elastic member elastically coupling the first and second rotary members therethrough to each other.

16. The power transmission device according to claim 15, wherein
the torque limiter includes a second side plate, and
the friction plate, the pressure plate, and the urging member are disposed axially between the first and second side plates.

17. The power transmission device according to claim 16, wherein the second side plate is disposed axially between the drive plate and the first side plate.

18. The power transmission device according to claim 15, wherein the elastic member is disposed radially inside the torque limiter.

19. The power transmission device according to claim 1, wherein
the torque fluctuation inhibiting device includes an annular portion extending in a circumferential direction, and
the first cylindrical portion is in contact at an inner peripheral surface thereof with an outer peripheral surface of the annular portion.

20. The power transmission device according to claim 2, wherein
the torque fluctuation inhibiting device includes an annular portion and a second cylindrical portion, the annular portion extending in a circumferential direction, the second cylindrical portion extending from an outer peripheral end of the annular portion in the axial direction, and
the first cylindrical portion overlaps with the second cylindrical portion as seen in a radial direction.
